(19) United States
(12) Patent Application Publication
(10) Pub. No.: US 2009/0199084 A1
(43) Pub. Date: Aug. 6, 2009

(54) Document processing device and document processing method

(75) Inventor: Daisuke Motohashi, Tokushima (JP)

Correspondence Address: SUGHRUE MION, PLLC, 2100 PENNSYLVANIA AVENUE, N.W., SUITE 800, WASHINGTON, DC, 20037, US

(73) Assignee: JustSystems Corporation, Tokushima (JP)

(21) Appl. No.: 11/630,837

(22) PCT Filed: Jun. 24, 2005
(86) PCT No.: PCT/JP05/11666

§ 371 Date: Dec. 22, 2006

(30) Foreign Application Priority Data
Jun. 25, 2004 (JP) 2004-187910

(51) Int. Cl. G06F 17/21; G06F 17/30

(52) U.S. Cl. 715/234; 707/103 R; 707/E17.055

(57) ABSTRACT

The namespace that is to be referred to for handling a document described in a markup language is identified.

A namespace detection unit 310 reads out an XML document which is a processing target, and detects the line where the namespace has been described. In a case that the correct namespace cannot be identified, a namespace identifying unit 312 searches for and narrows down the namespace candidates while referring to a namespace information storage unit 316. Then, the plug-ins that correspond to the namespace candidates thus narrowed down are loaded. A candidate screen display unit 314 displays the display candidates created according to the respective plug-ins so as to allow the user to select one from among these display candidates. The namespace information storage unit 316 stores beforehand the relation between the character strings, such as tag names and so forth, which are used as a key for obtaining the namespace and which are described in a document, and the corresponding namespaces.

### TECHNICAL FIELD

The present invention relates to a document processing technique, and particularly to a document processing apparatus and a document processing method for processing a structured document having a hierarchical structure.

### BACKGROUND ART

The XML (Extensible Markup Language) has been attracting attention as a format that allows the user to share data with other users via a network. This promotes the development of applications for creating, displaying, and editing XML documents (see Patent document 1, for example). The XML documents are created based upon a vocabulary (tag set) defined according to a document format definition.

XML permits the user to use multiple vocabularies in a single document. However, in some cases, such multiple vocabularies have the same element names or the same attribute names. In such a case, different elements having the same element name or different attributes having the same attribute name clash with one another. That is to say, this leads to a problem in that the vocabulary to which the element type or the attribute type belongs cannot be identified. In order to solve such a problem, XML introduced the “namespace” concept, which describes the vocabulary to which the element types and the attribute types used in a document belong.

However, a problem remains in such a technique as follows. That is to say, in a case that a description is missing or erroneous, the namespace cannot be identified, leading to a situation in which the document cannot be properly processed.

### [Patent Document 1]

Japanese Patent Application Laid-open No. 2001-290804

### DISCLOSURE OF INVENTION

### Problems to be Solved by the Invention

The present invention has been made in view of the aforementioned problems. Accordingly, it is an object of the present invention to provide a technique for performing proper processing for a structured document even if the information such as the namespace cannot be identified, thereby allowing such a document to be displayed and edited smoothly.

### Means for Solving the Problems

An aspect according to the present invention relates to a document processing apparatus. The document processing apparatus comprises: a namespace detection unit for detecting a namespace to which elements included in a document described in a markup language belong; and a namespace identifying unit having a function whereby, in a case that the correct namespace has not been detected, multiple document display files are applied to the document, and the display candidates thus created are displayed so as to allow the user to input an instruction to select a display candidate, thereby enabling the namespace to be identified. With such an arrangement, the document is displayed based upon the namespace, identified by the namespace detection unit or the namespace identifying unit, in a manner that allows the user to edit the document thus displayed.

The “markup language” may be a kind of XML, e.g., XHTML (Extensible HyperText markup Language), SVG (Scalable Vector Graphics), MathML (Mathematical Markup Language), etc. Also, examples of the markup languages include SGML (Standard Generalized Markup Language), HTML (HyperText Markup Language), etc. On the other hand, examples of the “multiple document display files” include: a file in which a definition has been described for translating a structured document such as an XML document such that it is displayed in the form of an XHTML document; a file for translating such a structured document such that it is displayed in the form of an SVG document; and a file for translating such a structured document such that it is displayed in the form of a MathML document; etc. Also, the “document display file” may be an executable program file such as a plug-in etc., for displaying a structured document such as an XML document etc. Examples of such executable program files include: a plug-in for displaying an XHTML document; a plug-in for displaying an SVG document; a plug-in for displaying a MathML document; etc.

Also, with the document processing apparatus, the namespace identifying unit may extract keywords from the document based upon a predetermined condition, and may narrow down the namespace candidates based upon the keywords thus extracted. Furthermore, the namespace identifying unit may apply the multiple document display files, which correspond to the respective namespace candidates, to the document. Also, the document processing apparatus may further comprise a namespace information storage unit for storing the information with respect to the relation between the keyword and corresponding namespace, and which is used as a reference when the namespace identifying unit narrows down the namespace candidates. Here, the keyword may be the element name (tag name), the attribute name, or the like, which has been described in the document, and which allows the namespace to be presumed.

The namespace information storage unit may store the information with respect to the relation between the namespace to which the elements included in a document belong, and the keywords included in the document, for every prior document each time a document is processed.

Another aspect according to the present invention relates to a document processing method. The document processing method comprises: a step for detecting a namespace to which elements included in a document described in a markup language belong; a step whereby, in a case that the correct namespace has not been detected, multiple document display files are applied to the document, and display is performed; and a step for identifying the namespace by receiving a selection instruction from the user with respect to the screen thus displayed. With such an arrangement, the document is displayed based upon the namespace thus detected or identified in a manner that allows the user to edit the document.

Note that any combination of the aforementioned components or any manifestation of the present invention realized by replacement of a system, a recording medium, and so forth, is effective as an embodiment of the present invention.

### [Advantages]

The present invention provides a technique for supporting appropriate processing for an structured document.

### BRIEF DESCRIPTION OF THE DRAWINGS

FIG. 1 is a diagram which shows a configuration of a document processing apparatus according to the background technique.

FIG. 2 is a diagram which shows an example of an XML document which is a processing target.

FIG. 3 is a diagram which shows an example in which the XML document shown in FIG. 2 is mapped to a table described in HTML.

FIG. 4(a) is a diagram which shows an example of a definition file used for mapping the XML document shown in FIG. 2 to the table shown in FIG. 3.

FIG. 4(b) is a diagram which shows an example of a definition file used for mapping the XML document shown in FIG. 2 to the table shown in FIG. 3.

FIG. 5 is a diagram which shows an example of a screen on which the XML document, which has been described in a marks managing vocabulary and which is shown in FIG. 2, is displayed after having been mapped to HTML according to the correspondence shown in FIG. 3.

FIG. 6 is a diagram which shows an example of a graphical user interface provided by a definition file creating unit, which allows the user to create a definition file.

FIG. 7 is a diagram which shows another example of a screen layout created by the definition file creating unit.

FIG. 8 is a diagram which shows an example of an editing screen for an XML document, as provided by the document processing apparatus.

FIG. 9 is a diagram which shows another example of an XML document which is to be edited by the document processing apparatus.

FIG. 10 is a diagram which shows an example of a screen on which the document shown in FIG. 9 is displayed.

FIG. 11 is a diagram which shows the configuration of a document processing apparatus according to an embodiment.

FIG. 12 is a flowchart which shows a procedure for identifying a namespace.

FIG. 13 is a diagram which shows an example of a screen on which document display candidates have been displayed.

FIG. 14 is a diagram which shows another example of a screen on which a document display candidate has been displayed.

FIG. 15 is a diagram which shows an example of a structure of a table which provides a relation between the tag name and the namespace.

### REFERENCE NUMERALS

20 document processing apparatus
22 main control unit
24 editing unit
30 DOM unit
32 DOM provider
34 DOM builder
36 output unit
40 CSS unit
42 CSS parser
44 CSS provider
46 rendering unit
50 HTML unit
52, 62 control unit
54, 64 edit unit
56, 66 display unit
60 SVG unit
72 document acquisition unit
74 namespace URI acquisition unit
76 definition file name creating unit
80 VC unit
82 mapping unit
84 definition file acquisition unit
86 definition file generator
300 document processing apparatus
310 namespace detection unit
312 namespace identifying unit
314 candidate screen display unit
316 namespace information storage unit

### BEST MODE FOR CARRYING OUT THE INVENTION

Description will be made below regarding the background technique for the present invention before detailed description of the present embodiment.

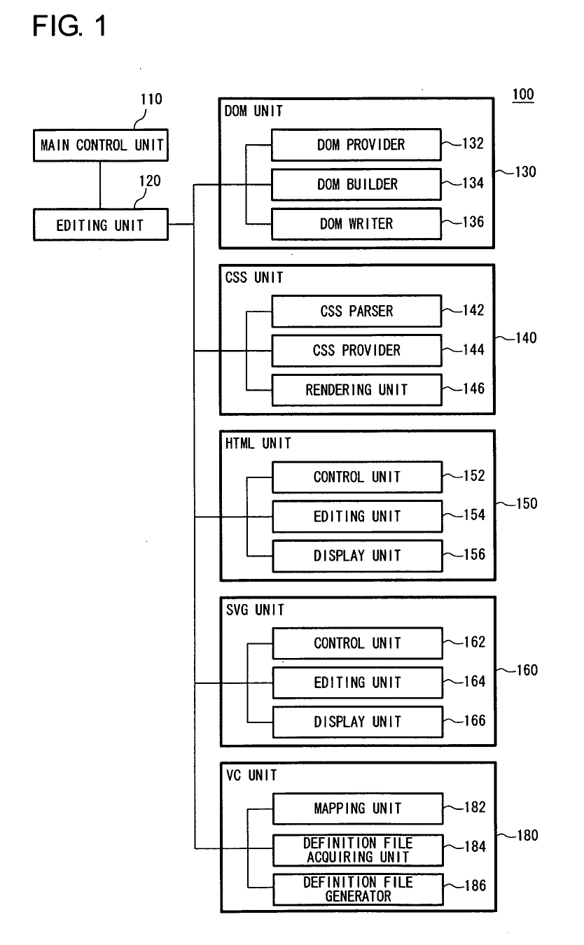

FIG. 1 illustrates a structure of a document processing apparatus 20 according to the background technique. The document processing apparatus 20 processes a structured document where data in the document are classified into a plurality of components having a hierarchical structure. Represented in the background technique is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it would be understood by those skilled in the art that these function blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, the HTML unit 50 and the SVG unit 60 are loaded, respectively. As will be described later, when compound documents, which contain both the HTML and SVG components, are to be processed, both the HTML unit 50 and the SVG unit 60 are loaded.

By implementing the above structure, a user can select so as to install only necessary functions, and can add or delete a function or functions at a later stage, as appropriate. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 generates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are generated. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

The HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the background technique allows an XML document to be edited according to each given vocabulary, as well as providing a function of editing the HTML document in the form of tree display. The HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the background technique, this function is called a vocabulary connection (VC). In the VC unit 80, the definition file acquiring unit 84 acquires a script file in which the mapping definition is described. Here, the definition file specifies the correspondence (connection) between the nodes for each node. Furthermore, the definition file may specify whether or not editing of the element values or attribute values is permitted. Furthermore, the definition file may include operation expressions using the element values or attribute values for the node. Detailed description will be made later regarding these functions. The mapping unit 82 instructs the DOM builder 34 to generate a destination tree with reference to the script file acquired by the definition file acquiring unit 84. This manages the correspondence between the source tree and the destination tree. The definition file generator 86 offers a graphical user interface which allows the user to generate a definition file.

The VC unit 80 monitors the connection between the source tree and the destination tree. Upon reception of an editing instruction from the user via a user interface provided by a plug-in that handles a display function, the VC unit 80 first modifies a relevant node of the source tree. As a result, the DOM unit 30 issues a mutation event indicating that the source tree has been modified. Upon reception of the mutation event thus issued, the VC unit 80 modifies a node of the destination tree corresponding to the modified node, thereby updating the destination tree in a manner that synchronizes with the modification of the source tree. Upon reception of a mutation event that indicates that the destination tree has been modified, a plug-in having functions of displaying/editing the destination tree, e.g., the HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 generates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and generates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

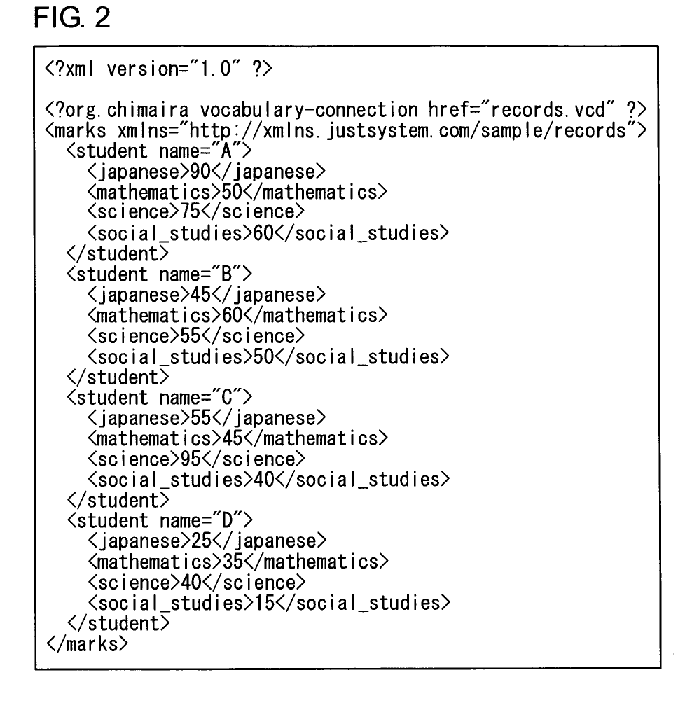

FIG. 2 shows an example of an XML document to be processed. According to this exemplary illustration, the XML document is used to manage data concerning grades or marks that students have earned. A component “marks”, which is the top node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the background technique does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

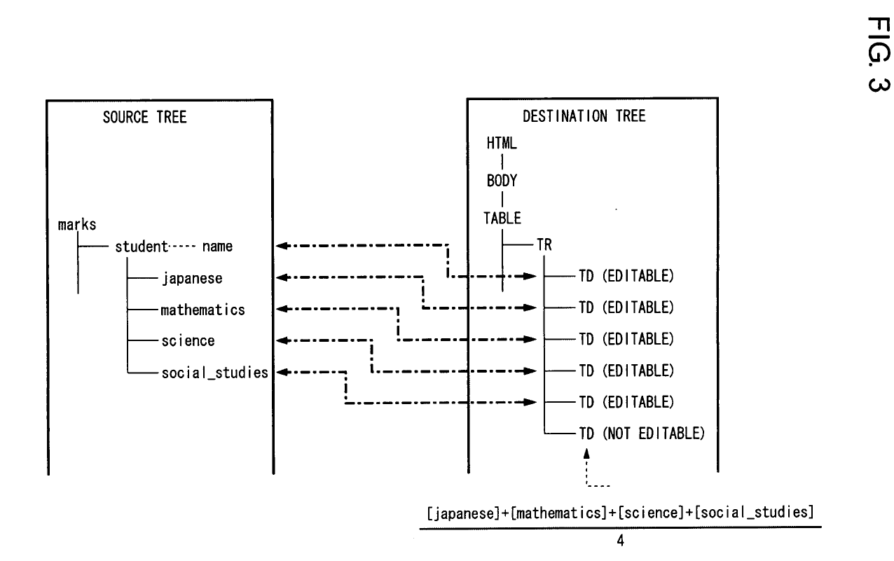

FIG. 3 shows an example in which the XML document shown in FIG. 2 is mapped to a table described in HTML. In an example shown in FIG. 3, a “student” node in the marks managing vocabulary is associated with a row (“TR” node) of a table (“TABLE” node) in HTML. The first column in each row corresponds to an attribute value “name”, the second column to a “japanese” node element value, the third column to a “mathematics” node element value, the fourth column to a “science” node element value and the fifth column to a “social_studies” node element value. As a result, the XML document shown in FIG. 2 can be displayed in an HTML tabular format. Furthermore, these attribute values and element values are designated as being editable, so that the user can edit these values on a display screen using an editing function of the HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

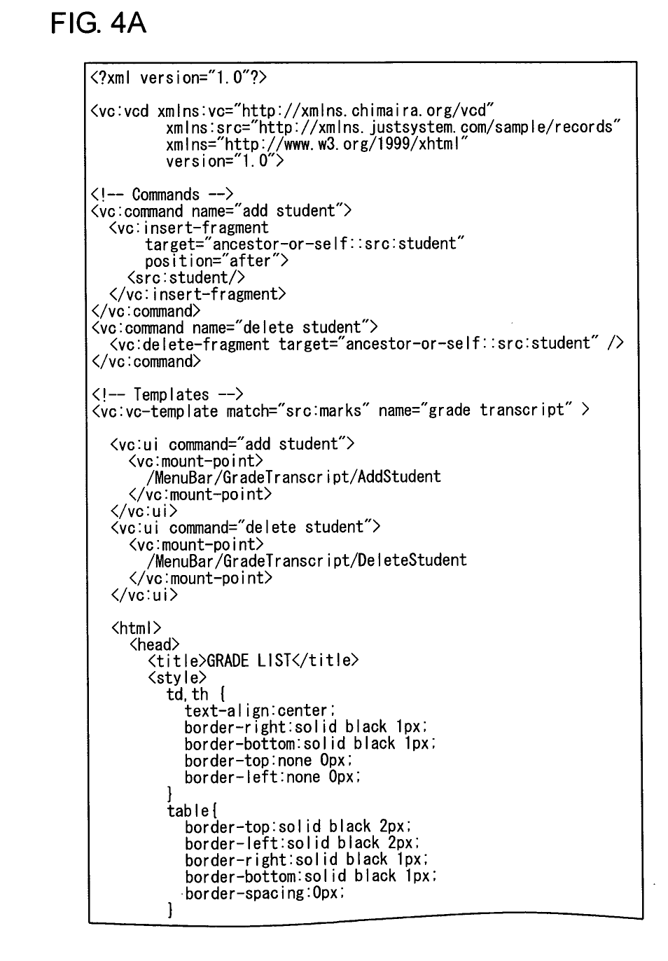

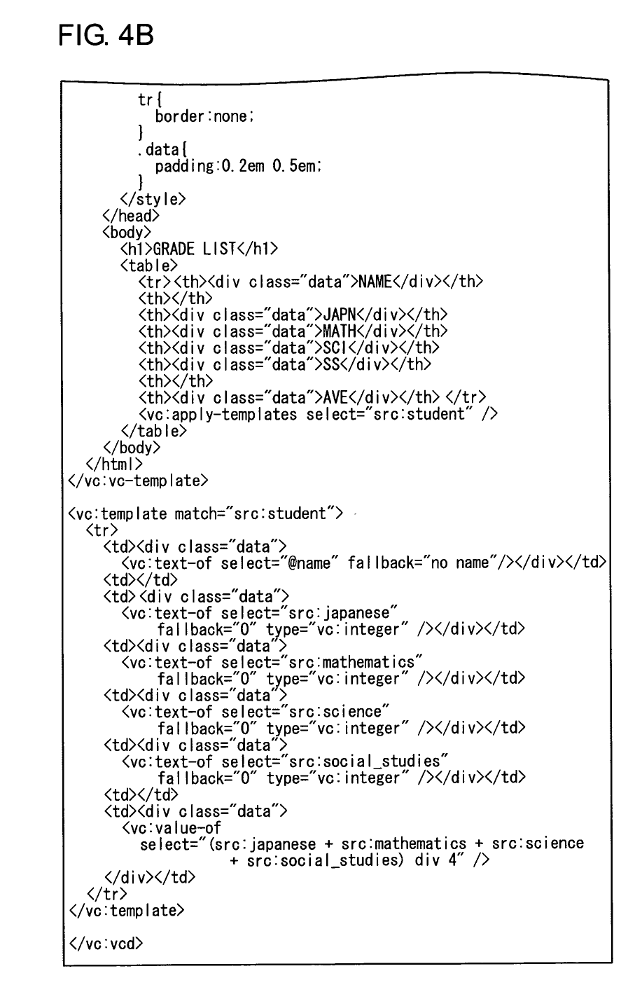

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a node “student” into a source tree and an operation of deleting the node “student” from the source tree, respectively, are associated with these commands. Furthermore, the definition file is described in the form of a template, which describes that a header, such as “name” and “japanese”, is displayed in the first row of a table and the contents of the node “student” are displayed in the second and subsequent rows. In the template displaying the contents of the node “student”, a term containing “text-of” indicates that editing is permitted, whereas a term containing “value-of” indicates that editing is not permitted. Among the rows where the contents of the node “student” are displayed, an operation expression “(src:japanese+src:mathematics+scr:science+scr:social_studies) div 4” is described in the sixth row. This means that the average of the student's marks is displayed.

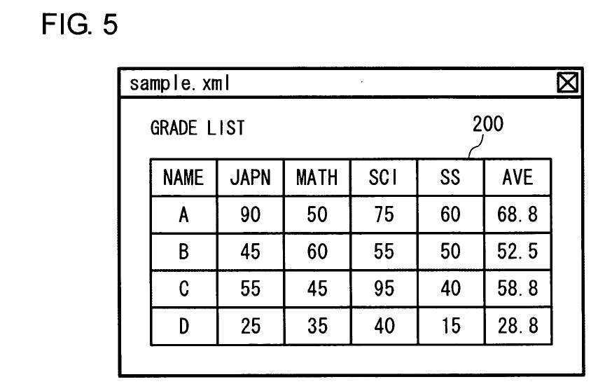

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the name of each student, marks for Japanese, marks for mathematics, marks for science, marks for social studies and the averages thereof. The user can edit the XML document on this screen. For example, when the value in the second row and the third column is changed to “70”, the element value in the source tree corresponding to this node, that is, the marks of student “B” for mathematics are changed to “70”. At this time, in order to have the destination tree follow the source tree, the VC unit 80 changes a relevant portion of the destination tree accordingly, so that the HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a node “student” is added or deleted in the source tree. In this manner, with the document processing apparatus 20 according to the background technique, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of the HTML unit 50.

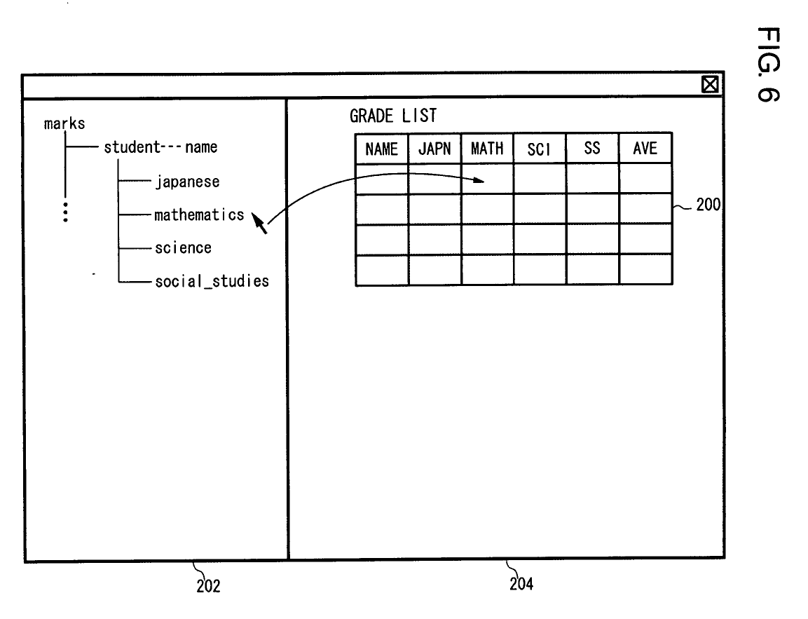

FIG. 6 shows an example of a graphical user interface, which the definition file generator 86 presents to the user, in order for the user to generate a definition file. An XML document to be mapped is displayed in a tree in a left-hand area 91 of a screen. The screen layout of an XML document after mapping is displayed in a right-hand area 92 of the screen. This screen layout can be edited by the HTML unit 50, and the user creates a screen layout for displaying documents in the right-hand area 92 of the screen. For example, a node of the XML document which is to be mapped, which is displayed in the left-hand area 91 of the screen, is dragged and dropped into the HTML screen layout in the right-hand area 92 of the screen using a pointing device such as a mouse, so that a connection between a node at a mapping source and a node at a mapping destination is specified. For example, when “mathematics,” which is a child element of the element “student,” is dropped to the intersection of the first row and the third column in a table 90 on the HTML screen, a connection is established between the “mathematics” node and a “TD” node in the third column. Either editing or no editing can be specified for each node. Moreover, the operation expression can be embedded in a display screen. When the screen editing is completed, the definition file generator 86 generates definition files, which describe connections between the screen layout and nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

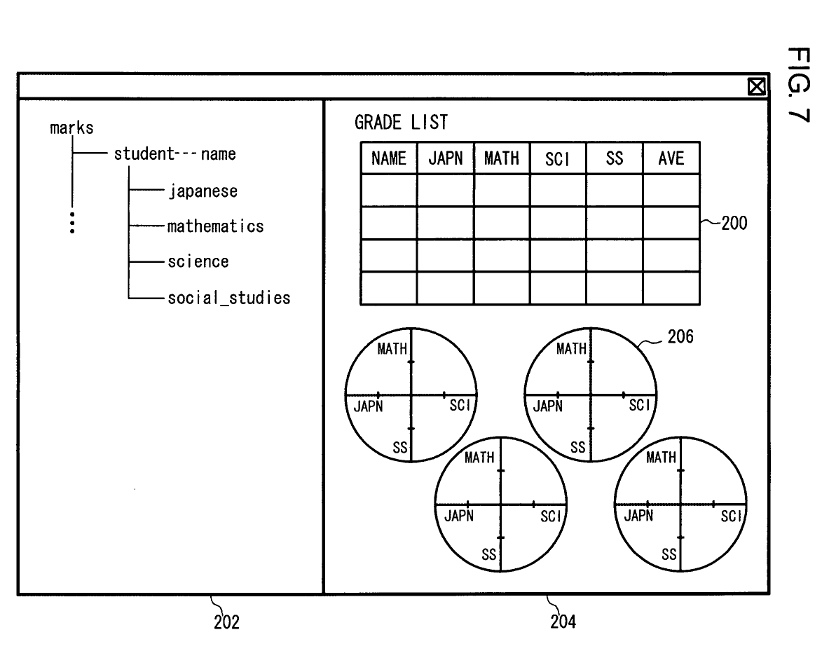

FIG. 7 shows another example of a screen layout generated by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the background technique can process a compound document described in the form of a single XML document according to a plurality of vocabularies. That is why the table 90 described in HTML and the circular graphs 93 described in SVG can be displayed on the same screen.

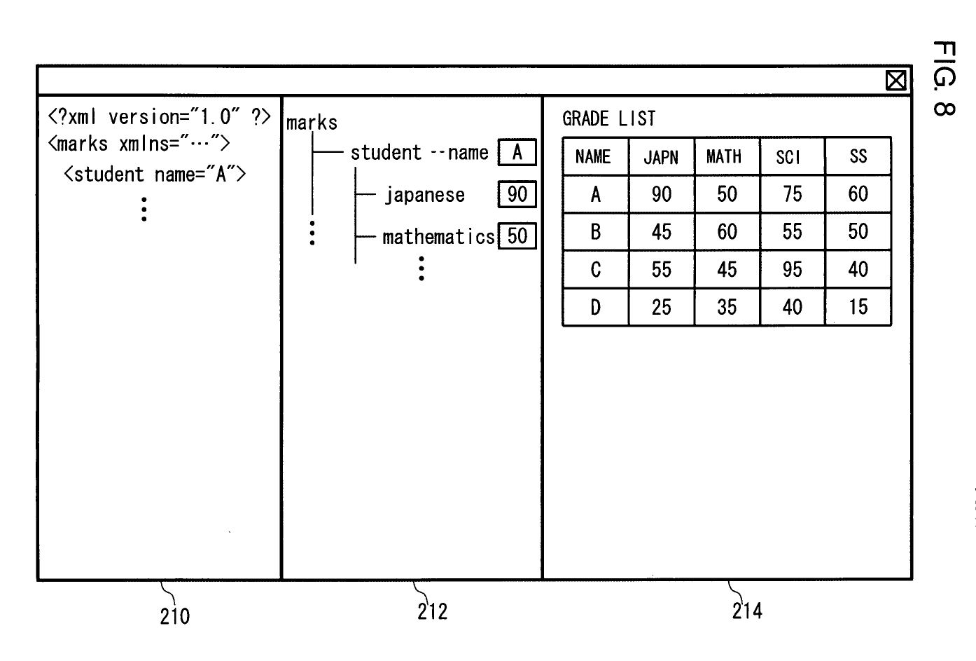

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, the HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to the HTML structure thus laid out, and the HTML unit 50 displays the XML document thus mapped. In such an arrangement, three destination trees in the source format, the tree format and the table format are generated. If the editing is carried out in any of the three areas on the screen, the VC unit 80 modifies the source tree and, thereafter, modifies the three destination trees in the source format, the tree format and the table format. Then, the HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

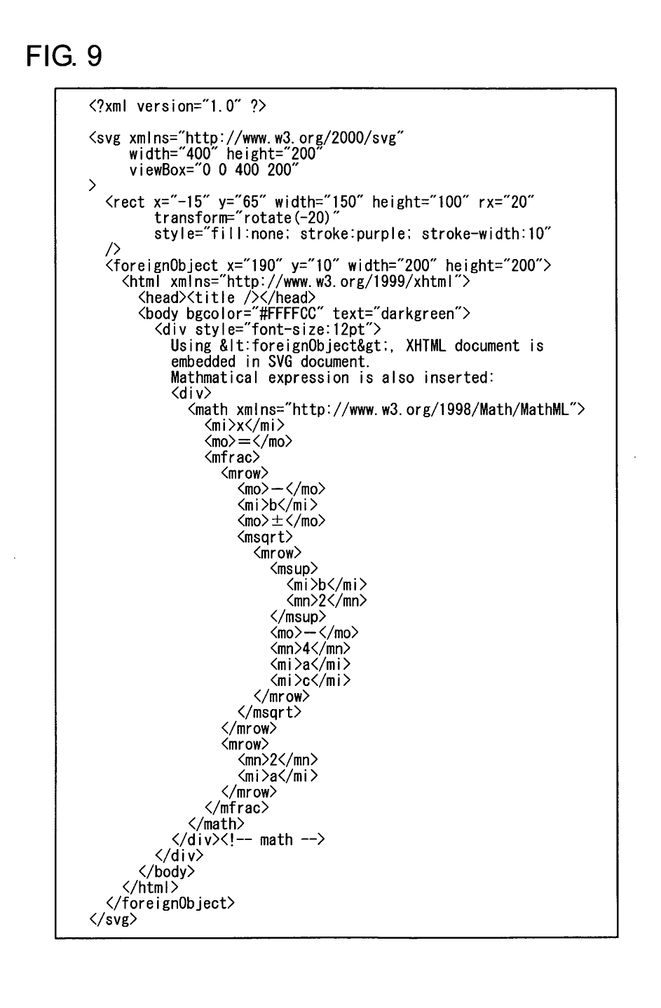

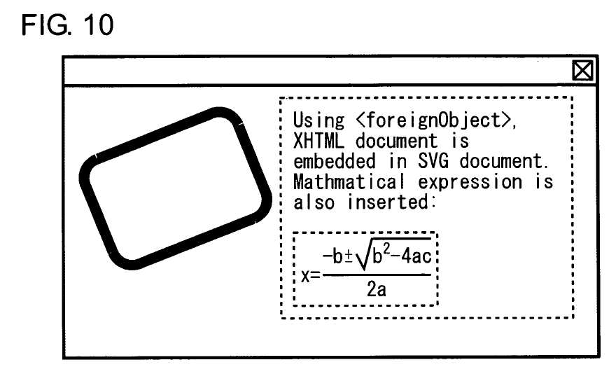

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs the HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by the HTML unit 50, or a command set which is defined in the definition file for mapping the HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the background technique, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the order of importance.

When the user edits a document on an edit screen as shown in FIG. 10, a plug-in or a VC unit 80, which is in charge of processing the edited portion, modifies the source tree. A listener for mutation events can be registered for each node in the source tree. Normally, a display unit of the plug-in or the VC unit 80 conforming to a vocabulary that belongs to each node is registered as the listener. When the source tree is modified, the DOM provider 32 traces toward a higher hierarchy from the modified node. If there is a registered listener, the DOM provider 32 issues a mutation event to the listener. For example, referring to the document shown in FIG. 9, if a node which lies lower than the <html> node is modified, the mutation event is notified to the HTML unit 50, which is registered as a listener to the <html> node. At the same time, the mutation event is also notified to the SVG unit 60, which is registered as a listener in an <svg> node, which lies upper to the <html> node. At this time, the HTML unit 50 updates the display by referring to the modified source tree. Since the nodes belonging to the vocabulary of the SVG unit 60 itself are not modified, the SVG unit 60 may disregard the mutation event.

Depending on the contents of the editing, modification of the display by the HTML unit 50 may change the overall layout. In such a case, the layout is updated by a screen layout management mechanism, e.g., the plug-in that handles the display of the highest node, in increments of display regions which are displayed according to the respective plug-ins. For example, in a case of expanding a display region managed by the HTML unit 50, first, the HTML unit 50 renders a part managed by the HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### Embodiment

Let us say that an information processing apparatus according to an embodiment of the present invention is configured on the basis of the aforementioned background technique, and the information processing apparatus according to the present embodiment includes the document processing apparatus according to the aforementioned background technique in the form of a part of the present embodiment. Now, description will be made in the present embodiment regarding an arrangement that provides a function of processing a document file structured with XML, which is an example of a structured document.

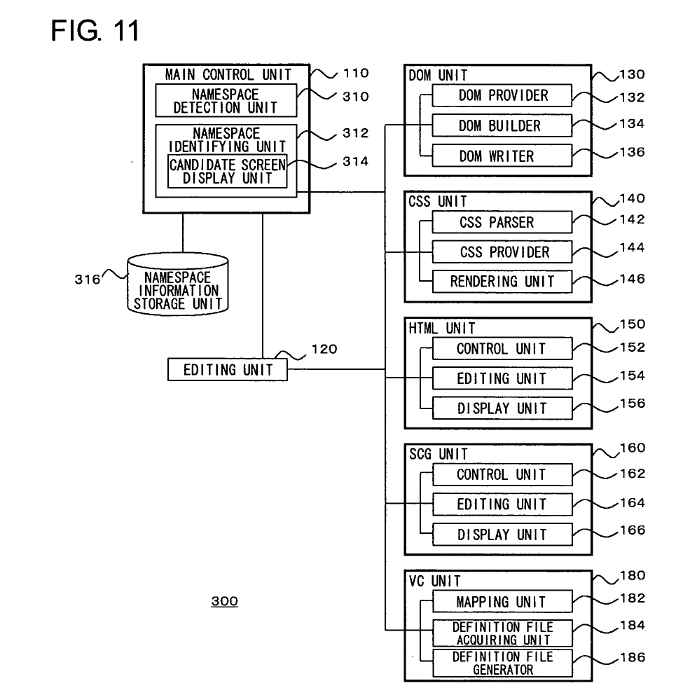

FIG. 11 shows a document processing apparatus 300 according to the present embodiment. In this drawing, the components denoted by the same reference numerals as those shown in FIG. 1 have the same or similar functions as those described above with reference to FIG. 1. A main control unit 110 of the document processing apparatus 300 according to the present embodiment includes a namespace detection unit 310 and a namespace identifying unit 312, which are new components provided in addition to the components shown in FIG. 1, and is connected to a namespace information storage unit 316. The main control unit 110 includes a namespace detection unit 310 and a namespace identifying unit 312, and is connected to a namespace information storage unit 316. The namespace identifying unit 312 includes a candidate screen display unit 314. The namespace detection unit 310 reads out an XML document which is a processing target, and detects a line which includes the information that allows the namespace to be identified, e.g., the line where the namespace URI has been described. In a case that the correct namespace has not been detected, e.g., in a case that the information that allows the namespace to be identified has not been detected, or in a case that the namespace URI thus detected is incorrect, the namespace identifying unit 312 receives a signal to that effect from the namespace detection unit 310. Then, the namespace identifying unit 312 narrows down the namespace candidates, and identifies the namespace. The candidate screen display unit 314 loads a plug-in that corresponds to the vocabulary for each namespace candidate, and displays the candidate screen. Then, the candidate screen display unit 314 allows the user to input an instruction regarding which namespace candidate is to be selected from among the candidate screens thus displayed. The namespace information storage unit 316 stores beforehand the information that indicates the relation between the namespace and the character string which serves as a key for identifying the namespace, e.g., the element name (tag name) or the attribute name described in the document. The information that indicates such a relation will be described later. Examples of such information include a table in which the tag name “html” is associated with the namespace URI “http://www.w3.org/1999/xhtml”.

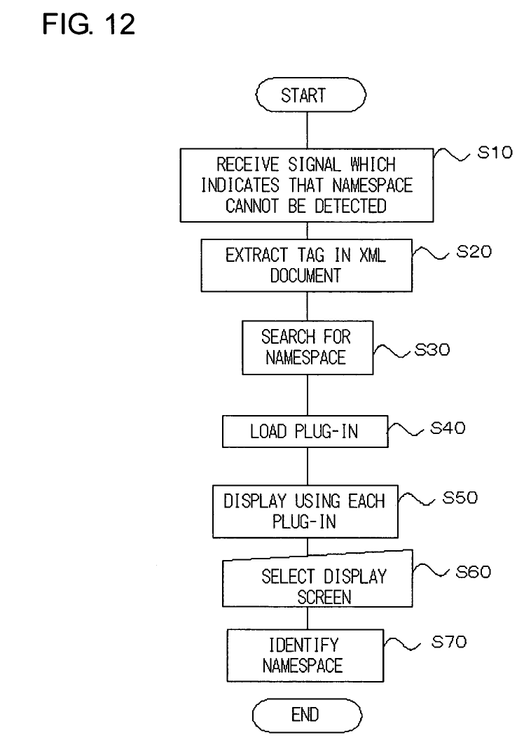

FIG. 12 is a flowchart which shows the procedure executed by the namespace identifying unit 312 for narrowing down the namespace candidates, and, in the final stage, identifying the namespace. First, upon reception of a signal from the namespace detection unit 310 to the effect that the correct namespace has not been identified in the processing target XML document (S10), the namespace identifying unit 312 extracts the tag names described in the XML document (S20). Here, the namespace identifying unit 312 may extract the attribute names instead of the tag names. Description will be made below regarding an arrangement employing the tag names as keywords. The namespace identifying unit 312 searches the namespace information storage unit 316 for the namespace based upon the tag names thus extracted, using a predetermined method as described later (S30). The search may be performed based upon all the tag names thus extracted. Then, the namespace identifying unit 312 loads a plug-in that corresponds to the vocabulary selected based upon each namespace candidate thus detected (S40). Furthermore, the namespace identifying unit 312 displays a screen in each candidate display format (S50). Let us consider a case in which the probability has been calculated for each namespace in the aforementioned search for the namespace. In this case, an arrangement may be made in which the namespace candidates are narrowed down according to a predetermined rule, e.g., only the top three namespace candidates are selected in descending order of probability as the narrowed-down candidates. Subsequently, the namespace identifying unit 312 receives a selection instruction from the user with respect to the candidates thus displayed (S60). Then, the namespace identifying unit 312 selects the namespace that corresponds to the plug-in for the display format selected by the user, thereby identifying an appropriate namespace (S70). Let us consider a case in which a single namespace has been detected in S30. In this case, an arrangement may be made in which the corresponding plug-in is loaded, and display is performed in the same way as described above, thereby allowing the user to confirm the namespace in the final stage.

Examples of the keywords used for narrowing down the namespace candidates include the file type extension included in the file name of a processing target XML document. Also, such examples include a combination of the file type extension, the tag names, and the attribute names.

Also, an arrangement may be made in which, in a case that the namespace has not been detected based upon the tag names in S30, the candidate screen display unit 314 displays the source code or the tree structure of the XML document. In this case, such an arrangement may notify the user to the effect that the namespace cannot be detected. Also, an arrangement may be made which allows the user to directly edit the XML document, e.g., which allows the user to insert the namespace URI into the XML document.

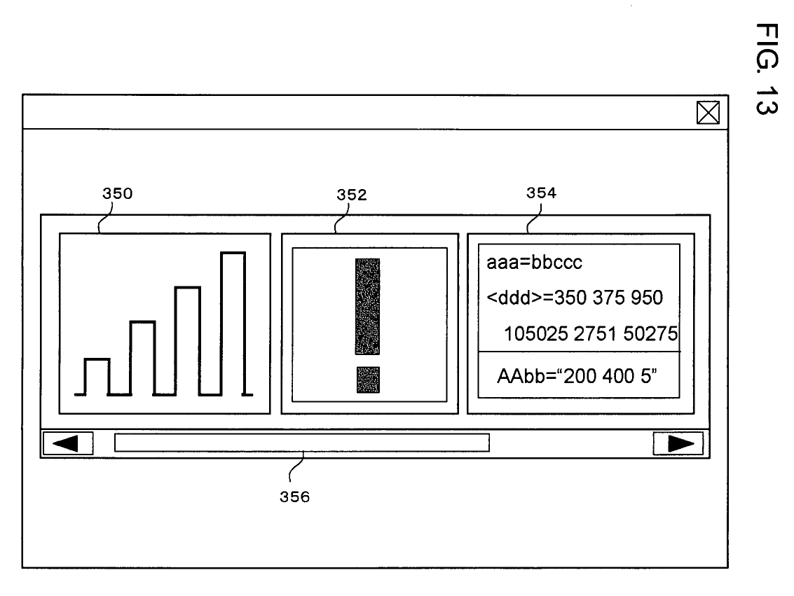

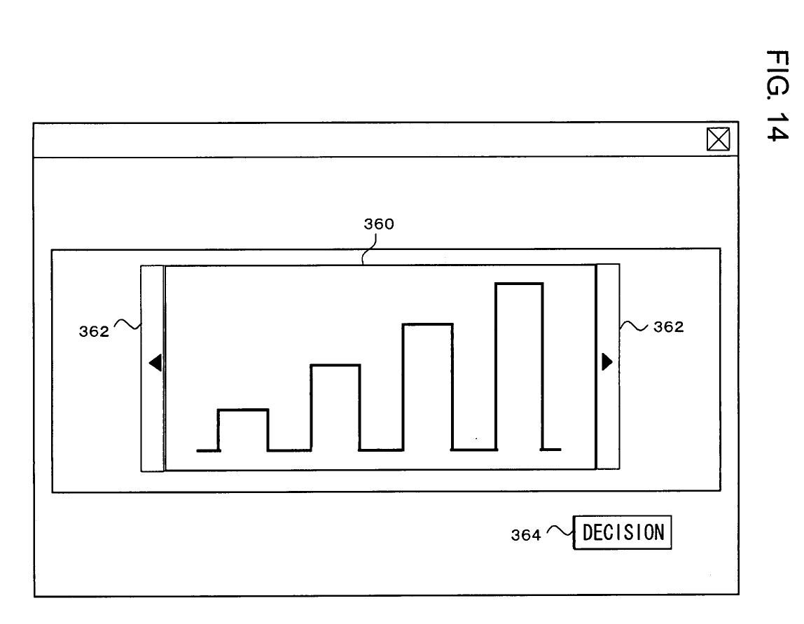

FIG. 13 and FIG. 14 show examples of the screens on which the candidate screen display unit 314 displays the document display candidates. FIG. 13 shows an example in which all the plug-in candidates are severally applied to the XML document at one time, and the resulting set of document display candidates are displayed along the horizontal direction. Specifically, the first candidate, the second candidate, and the third candidate are displayed in the regions 350, 352, and 354. Let us consider a case in which there are many plug-in candidates. In this case, such an arrangement may provide a scrollbar 356 that allows the user to scroll the screen. On the other hand, FIG. 14 shows an example in which the plug-in candidates are displayed one at a time on the screen. With such an arrangement, the plug-in is applied to the XML document according to an instruction from the user. Specifically, first, the plug-in that corresponds to the first namespace candidate is applied to the XML document, and the document display candidate thus created is displayed in the region 360. Then, upon clicking a next candidate button 362, the plug-in that corresponds to the second namespace candidate is applied to the XML document, and the document display candidate thus created is displayed in the region 360. In either display format, such an arrangement provides a function of allowing the user to select an appropriate plug-in by double-clicking the button or by clicking a decision button 364 on the screen where the plug-in has been applied to the XML document.

Such an arrangement has a function of automatically narrowing down the namespace candidates, and providing the namespace candidates thus narrowed down, even if the description with respect to the information that allows the namespace to be identified is missing or erroneous. This enables the user to perform the document processing smoothly by without troublesome operations, e.g., a manual search for the portion where the namespace is missing, a manual search for the namespace, etc. Thus, such an arrangement reduces the time cost. Furthermore, the present embodiment can be employed as a technique for avoiding the system crashes which often occur in reading out such an XML document. Such an arrangement allows the user to restore the document while validating it by eye, thereby offering a user-friendly document processing apparatus which is easy to understand.

With the background technique of the present embodiment, an XML document is mapped to HTML or SVG using the VC function based upon the definition file that corresponds to the vocabulary of the XML document, thereby enabling the document to be edited and displayed using the plug-in for the mapping destination.

Description has been made with reference to FIG. 12 regarding an arrangement in which the namespace candidates are selected based upon the tag names which are included in the XML document and which allow the namespace to be presumed. Furthermore, with such an arrangement, the document is displayed using a plug-in that corresponds to each vocabulary. Now, let us consider a case in which a definition file is declared. In this case, a document can be displayed and edited by mapping the document using the definition file. On the other hand, let us consider a case in which the document is a compound document having a vocabulary for which the namespace cannot be identified. In this case, an arrangement may be made in which the namespace candidates are selected based upon the tag names included in this portion, and the namespace candidates thus selected are displayed so as to allow the user to select one from among the namespace candidates in the same way as described above.

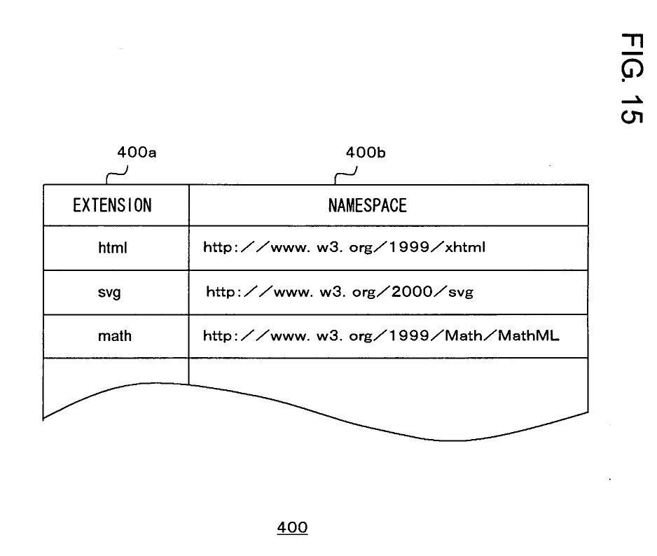

Examples of the methods for searching for the namespace include a rule-based technique, and probabilistic methods such as the SVM, the Bayes theorem, etc. FIG. 15 shows a simple example of a table stored in the namespace information storage unit 316, i.e., a table structure example 400 which provides the relation between the first-layer tag name and the namespace, and which is used as a reference table in the rule-based search. This table consists of tag name fields 400a and namespace fields 400b. For example, let us say that the first layer tag name “html” has been detected from the processing target XML document. In this case, there is a strong probability that the namespace URI of the document is “http//www.w3.org/1999/xhtml”. On the other hand, in a case that the first layer tag name “svg” has been detected, there is a strong probability that the namespace URI of the document is “http//www.w3.org/2000/svg”. On the other hand, in a case that the first layer tag name “math” has been detected, there is a strong probability that the namespace URI of the document is “http//www.w3.org/1999/Math/MathML”. The user or the system builder creates such a table beforehand, and stores the table in the storage unit 316. From the perspective of calculation costs, the rule-based search method as described above is effectively applied to an arrangement for handling widely known namespaces. In order to improve the search precision, an arrangement may be made which employs a complex search, i.e., a search performed based upon the tag names included in multiple layers, e.g., the tag names included in the first layer and the second layer.

On the other hand, the probabilistic method provides probability calculation based upon a tag name count. The probabilistic method is based upon the fact that an XHTML document has a number of “p” tags and “div” tags, and a MathML document has a number of “mi” tags and “mo” tags, for example. Before the search for the namespace using the probabilistic method, documents for which the namespace has been confirmed are read out beforehand in the form of teacher data, and the namespaces of the documents, the tag names included in the documents, and the tag name counts of the tag names included in the documents are stored in the namespace information storage unit 316. In these processing steps, the namespace detection unit 310 and the namespace identifying unit 312 provide the tag name extraction function. That is to say, these processing steps are achieved by transporting data from the namespace detection unit 310 and the namespace identifying unit 312 to the namespace information storage unit 316. Now, let us consider a case in which an XML document for which the namespace cannot be identified is processed. In this case, the tag names extracted from the processing target document by the namespace identifying unit 312 are compared with the tag names which have been extracted from the teacher data and which have been stored in the namespace information storage unit 316. Then, a predetermined calculation is performed while referring to each namespace to which the tag name extracted by the comparison belongs. Also, an arrangement may be made employing a rule in which the probability is weighted with an weighting factor adjusted for each layer such that the shallower the tag name layer is, the greater the weighting factor is. This improves the probability precision.

Also, an arrangement may be made in which the information with respect to the XML document is stored in the namespace information storage unit 316 in the form of teacher data each time an XML document, including a description that allows the namespace to be identified, is processed. Such an arrangement enables the namespace information to be stored corresponding to the way the individual user tends to operate his/her own document processing apparatus. At the same time, the least probable namespace candidates are eliminated from the candidates. Such an arrangement allows the namespace candidate to be effectively narrowed down.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention. Some of such possible modifications will be listed below.

Description has been made in the embodiment regarding an arrangement for processing an XML document. Also, the document processing apparatus 300 has a function of processing other markup languages, e.g., SGML, HTML, etc.

Also, an arrangement may be made in which the namespace identifying unit 312 applies all the plug-ins that can be installed to the processing target document, and displays all the screens that can be displayed such that they conform to the vocabulary of the processing target document, on the candidate screen display unit 314 without narrowing down the namespace candidates. After the display candidates are displayed, such an arrangement allows the user to input an instruction to select the screen display candidate in the same way as the above-described technique, thereby identifying the namespace. Such an arrangement reduces calculation costs for the step of narrowing down the namespace candidates. Such an arrangement is effectively applied to a case for handling a small total number of plug-ins. Also, an arrangement may be made in which all the definition files, based upon the background technique, that can be read out are applied to the processing target document, and all the screens that can be displayed are displayed so as to allow the user to input an instruction to select the display candidate. With such an arrangement, the definition files may be stored at positions that differ from one another according to the processing type. Furthermore, such an arrangement may allow the user to specify the reference position before the definition file is applied to the document. Such an arrangement provides the same advantages as those provided by the aforementioned arrangement in which the definition files that are to be applied to the document are narrowed down. Accordingly, such an arrangement allows the document to be effectively displayed and edited even if the document is an XML document having no information that would allow the namespace to be identified, and having no declared definition file. Also, XSLT (Extensible Stylesheet Language Transformations) or other XML display scripts may be applied to the document, in addition to the definition files based upon the background technique. With such an arrangement, in a case that any of the display candidates thus created can be displayed, determination is made that the namespace that corresponds to the display candidate that can be displayed is a namespace that conforms to the vocabulary of the translated document. In this case, such an arrangement provides an option to display and edit the processing target XML document using the plug-in that corresponds to the namespace thus determined.

### INDUSTRIAL APPLICABILITY

The present invention can be applied to a document processing apparatus for processing a structured document.

1. A document processing apparatus comprising:
a namespace detection unit for detecting a namespace to which elements included in a document described in a markup language belong; and
a namespace identifying unit having a function whereby, in a case that the correct namespace has not been detected, a plurality of document display files are applied to the document, and the display candidates thus created are displayed so as to allow the user to input an instruction to select a display candidate, thereby enabling the namespace to be identified,
wherein the document is displayed based upon the namespace, identified by said namespace detection unit or said namespace identifying unit, in a manner that allows the user to edit the document thus displayed.

2. A document processing apparatus according to claim 1, further comprising a namespace information storage unit for storing the information with respect to the relation between the namespace and corresponding keyword,
wherein said namespace identifying unit extracts the keywords from the document, selects the namespace candidates by searching said namespace information storage storage unit based upon the keywords thus extracted, and applies the multiple document display files, which correspond to the respective namespace candidates, to the document.

3. A document processing apparatus according to claim 2, wherein said keywords are element names or the attribute names of elements.

4. A document processing apparatus according to claim 2, wherein said namespace information storage unit stores the information with respect to the relation between the namespace to which the elements included in a document belong, and the keyword included in the document, for every prior document each time a document is processed.

5. A document processing method comprising:
a step for detecting a namespace to which elements included in a document described in a markup language belong;
a step whereby, in a case that the correct namespace has not been detected, a plurality of document display files are applied to the document, and display is performed; and
a step for identifying the namespace by receiving a selection instruction from the user with respect to the screen thus displayed,
wherein the document is displayed based upon the namespace thus detected or identified in a manner that allows the user to edit the document.

6. A computer program that allows a computer to provide:

6. A computer program that allows a computer to provide:
a function of detecting a namespace to which elements included in a document described in a markup language belong;
a function whereby, in a case that the correct namespace has not been detected, a plurality of document display files are applied to the document, and display is performed;
a function of identifying the namespace by receiving a selection instruction from the user with respect to the screen thus displayed; and
a function of displaying the document, based upon the namespace thus detected or identified in a manner that allows the user to edit the document.

7. A document processing apparatus according to claim 3, wherein said namespace information storage unit stores the information with respect to the relation between the namespace to which the elements included in a document belong, and the keyword included in the document, for every prior document each time a document is processed.
